(19) United States
(12) Patent Application Publication
(10) Pub. No.: US 2005/0192000 A1
(43) Pub. Date: Sep. 1, 2005

(54) Content distribution

(75) Inventor: Richard Lloyd, Surbiton (GB)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/026,375

(22) Filed: Dec. 29, 2004

(30) Foreign Application Priority Data
Dec. 29, 2003 (GB) 0330099.3

(51) Int. Cl. H04M 3/00

(52) U.S. Cl. 455/420; 455/418

(57) ABSTRACT

Electronic content is downloaded from a content provider 3 and used by a first mobile communication device 2. On a request of a friend or on a user's own initiative, the user may activate the mobile communication device 2 to cause the content be redistributed from the content provider 3 to another mobile communication device 2 of the friend, by sending a pointer to both the friend and the content to the content provider 3 or by sending a pointer to both the content provider 3 and the content to the mobile communication device 2 of the friend for further relaying to the content provider 3. Responsive to receiving a pointer either way, the content provider 3 is provided with sufficient information to redistribute the content to the mobile communication device 2 of the friend without need for manual set-up of an access between the friend's mobile communication device 2 and the content provider 3.

This invention relates to electronic content distribution. The invention relates particularly, but not exclusively, to distributing electronic content based on a pointer provided by a subscriber.

The development of new end-to-end distribution methods based on electronic information transfer enable a range of new services such as distribution of music, video and games content. As in traditional record sales business, the content is provided against a charge, but thanks to the electronic information transfer, the delivery is independent of physical movement of parcels and can take countless forms such as Internet transmissions and wireless circuit switched or packet based transmissions. Particularly in the wireless or mobile communications with portable devices, the limitations of the user interface may hinder this business by making it harder to search and select desired content. Even the establishment of a communication channel for retrieving or receiving content from a service provider has proven to be sometimes difficult. For instance, when using Wireless Application Protocol (WAP), various addresses, contact numbers, communications modes etc. may be required before the communications can even start.

When facing the vast amount of electronic content available, it is becoming also increasingly difficult to choose the desired content. It has turned out that the word of mouth still often beats the advanced search engines. One might notice desired content used by a friend and ask where the content was obtained from, but the computer-age addresses are difficult to remember and therefore obtaining the content may require considerable effort. Even when knowing the identity of the content and the service provider, browsing through complex selection structures may be required over a wireless link with per-minute charges. Whilst it is technically possible to solve this problem by forwarding the content directly from one subscriber terminal to another, this technology is commercially undesirable as it may damage the business of the original service provider and also deprives the author or copyright owner of the content from his or her awards. Further, the content then needs to be transmitted over the air twice, over both an uplink and a downlink thus wasting the precious radio resource.

It is desirable to facilitate the distribution of electronic content in a situation where a person may observe another person using the content and becomes interested in obtaining that content.

According to a first aspect of the invention there is provided a mobile communication device, comprising:
a receiver for receiving electronic content from a content provider;
a user interface for receiving a user command;
a transmitter configured to cause the content provider to deliver the content to another mobile communication device responsive to the user command.

By causing a content provider to deliver the content to another mobile communication device on user command, the content provider can take care of charging and copyrights management so that the problems associated with direct content forwarding can be avoided. Further, a single user command at a mobile communication device may suffice to cause the delivery of a desired content to another mobile communication device used by, for instance, a friend.

The mobile communication device may comprise an input for receiving a user command to cause presently used content to be delivered to the another mobile communication device. The input may comprise a dedicated key or speech recognition means configured to recognise a single key actuation or spoken command. The input may comprise a communication port configured to receive the command from the another mobile communication device. The mobile communication device may comprise means for checking the authorisation of the command particularly if received from the another mobile communication device, for example, by comparing the command to a predetermined code such as a PIN code.

The input provides a quick and easy way to cause commonly desirable content be shared to a friend. Allowing provision of the command by the another mobile communication device makes it possible for the friend to draw a pointer to the content without forcing the use of the content be interrupted. This is particularly advantageous with games wherein restarting the playing risks the continuity of the game as is the case with adventure games.

The content may be a game playable with a mobile communication device. Alternatively, the content may be content to be presented such as video, music or news content.

The transmitter may have been configured to transmit an identifier associated with the content to the content provider and an identification of the another mobile communication device. The identifier and identification may be transmitted together.

By transmitting the identifier and identification to the content provider the content provider can be furnished with all information necessary to push the content to the another mobile communication device.

The identifier may be a checksum computed on the content or a predetermined part of the content, such as a Message Digest Algorithm version 5 (MD5) checksum commonly used to check the integrity of applications for anti-tampering purposes.

Using a computed identifier removes the need to store any associated information. Since practically each content corresponds to a unique checksum, the checksum is well fitted to be used as an identifier of the content. The content provider may hold a look-up table indexed by the checksums of the different contents provided to quickly identify the content in question when receiving the checksum.

The identifier may contain an identifier received from the content provider before, after or on receiving the content. The identifier may comprise man and/or machine readable information. The identifier may comprise a computer executable code sequence adapted to cause a mobile communication device to start fetching the content from the content provider. The computer executable program code sequence may be based on an open source and/or inter-platform computer program code instruction set such as Java developed by Sun®. The computer executable program code sequence may comprise all the information necessary to initiate a communication link with the content provider.

The transmitter may be configured to send the identifier to the another mobile communication device to cause the delivery of the content to the another mobile communication device. The transmitter may be configured to send the identifier over a point-to-point connection. The point-to-point connection may be a short range wireless connection such as a Low Power Radio Frequency (LPRF) link, acoustic link such as ultrasound link or an optical link such as an infrared link.

Causing the delivery of the content to the another mobile communication device by sending the identifier to the another mobile communication device over the point-to-point connection may be free of charge.

According to a second aspect of the invention there is provided a content provider, comprising:
an input for receiving from a first mobile communication device a content delivery request, an identifier associated with the content and an identification of a second mobile communication device;
an access to a collection of different contents;
a content finder configured to find a particular content based on the received identifier;
an output for outputting the content requested for the second mobile communication device

The input may have been configured to deliver the content to the first mobile communication device and later responsive to the delivery request to deliver the content to the second communication device.

The content provider may comprise an identifier combiner configured to combine an identifier associated with the content before or on delivering the content to the first mobile communication device. Alternatively, the contents in the collection may readily combine respective identifiers.

According to a third aspect of the invention there is provided a content identifier, comprising means for initiating a data communications link with a content provider and means for identifying a particular content for downloading that content from the content provider.

According to a fourth aspect of the invention there is provided a content delivery system comprising a content provider according to the second aspect of the invention and a mobile communication device according to the first aspect of the invention.

The content delivery system may further comprise a mobile telecommunications network for relaying information between the content provider and the mobile communication device. The network may further relay the identifier from the mobile communication device to the another mobile communication device.

According to a fifth aspect of the invention there is provided a computer program product for controlling a mobile communication device to operate as a mobile communication device according to the first aspect.

According to a sixth aspect of the invention there is provided a computer program product for controlling a content provider to operate as a content provider according to the second aspect.

According to a seventh aspect of the invention there is provided a method of distributing content comprising:
sending electronic content from a content provider to a mobile station;
receiving at the mobile station a user command via a user interface; and
in response to the user command, sending a message from the mobile station to the content provider to cause delivery of the content to another mobile communication device.

According to an eighth aspect of the invention there is provided a method of distributing content, comprising:
receiving from a first mobile communication device a content delivery request, an identifier associated with the content and an identification of a second mobile communication device at a content provider;
finding a particular content at the content provider based on the received identifier;
outputting the requested content from the content provider to the second mobile communication device.

It should be appreciated that the embodiments of any one aspect may produce corresponding advantages when combined with different other aspects as well and that they can be combined where applicable.

The invention will now be described, by way of example only, with reference to the accompanying drawings, in which:

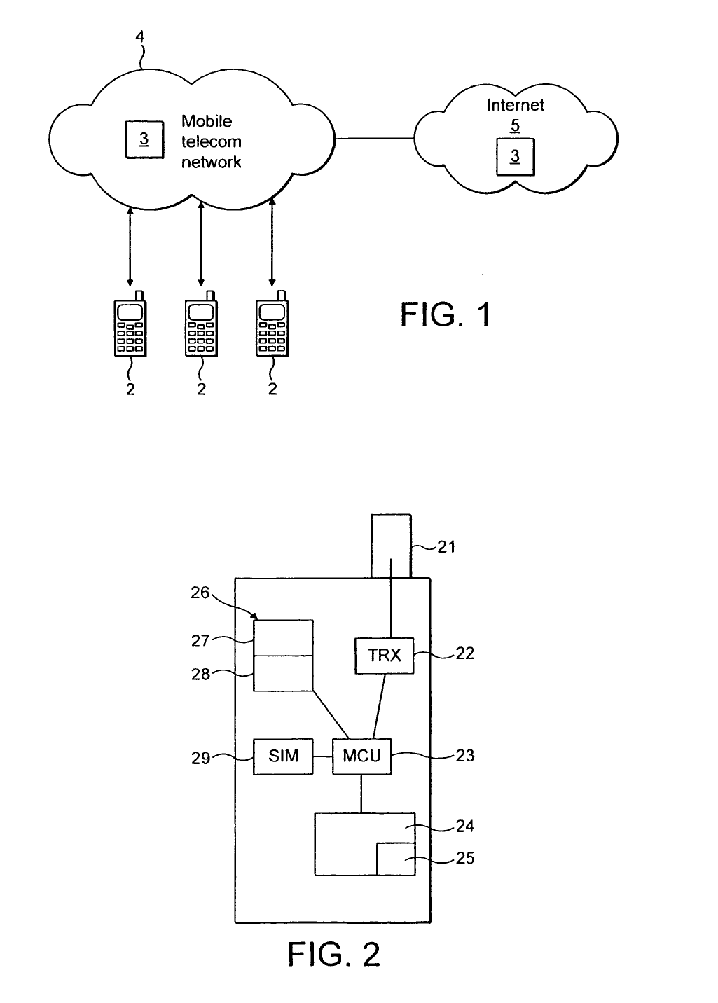

FIG. 1 shows a schematic system diagram according to a preferred embodiment of the invention;

FIG. 2 shows a block diagram of a mobile communication device of FIG. 1;

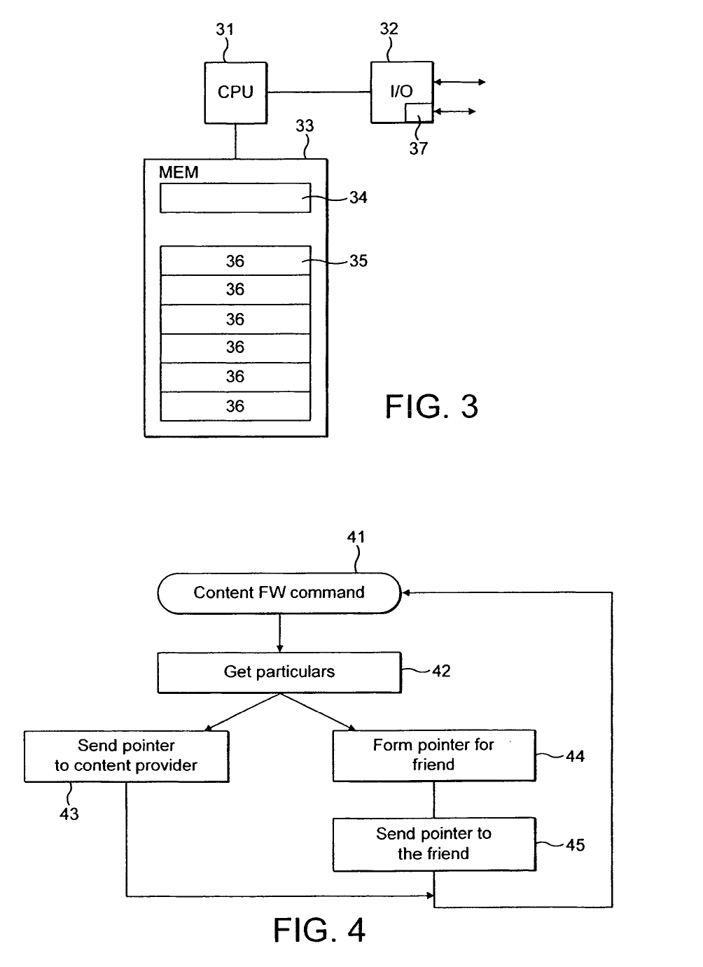

FIG. 3 shows a block diagram of a content provider of FIG. 1;

FIG. 4 shows a flow chart illustrating the operation of the mobile communication device of FIGS. 1 and 2 when sending a pointer to a desired content;

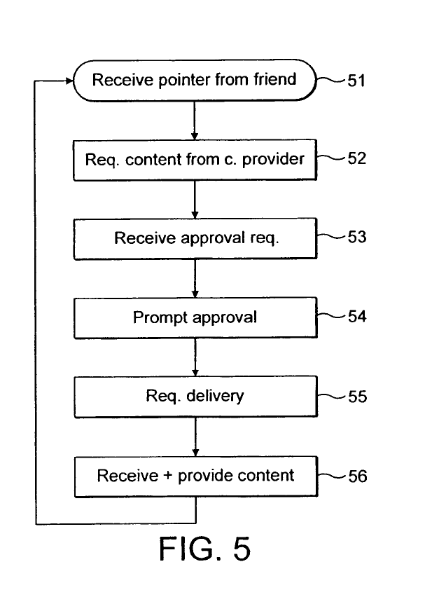

FIG. 5 shows a flow chart illustrating the operation of the mobile communication device of FIGS. 1 and 2 when receiving a pointer to a desired content;

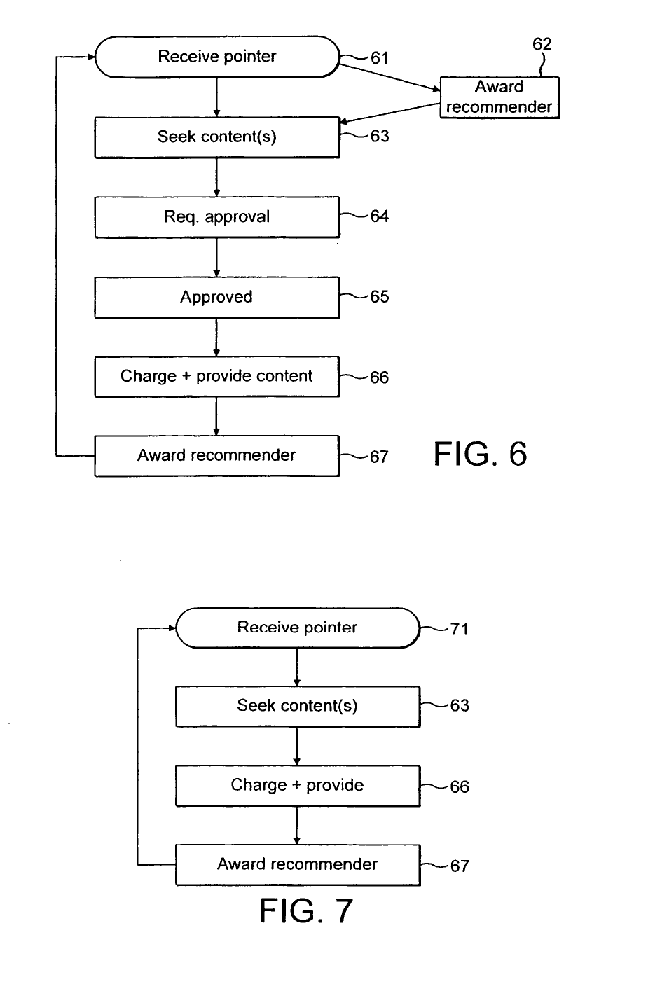

FIG. 6 shows a flow chart illustrating the operation of the content provider of FIG. 1 in one embodiment; and

FIG. 7 shows a flow chart illustrating the operation of the content provider of FIG. 1 in another embodiment.

FIG. 1 shows a schematic system diagram according to a preferred embodiment of the invention. A content delivery system 1 comprises a plurality of mobile communication devices 2, a group of content providers 3 and a mobile communications network 4 interfacing the mobile communication device and the content provider 3. The content providers 3 may either be contained within the mobile communications network 4 or be connected thereto via other networks such as further or fixed communications networks including the Internet 5.

FIG. 2 shows a block diagram of a mobile communication device 2 of FIG. 1. The mobile communication device 2 is preferably a cellular phone which may be Java-enabled but may also be a satellite phone or data-only device, The mobile communication device 2 comprises an antenna 21, a transceiver 22, a processor 23 (e.g. a Master Control Unit MCU), a non-volatile memory 24 containing software 25, a User Interface (UI) 26 with an input section 27 and output section 28 and a Subscriber Identity Module (SIM) 29 that may be user replaceable, permanently embedded or integrated into the mobile communication device 2, for instance. The SIM may be a UMTS Subscriber Identity Module (USIM) or a User Identity Module (UIM). The antenna 21 has been connected to the transceiver 22 to provide radio communications down from and up to a base station of the mobile communication network 4. The processor 23 controls the operation of the mobile communication device 2 and is connected either directly or via other circuitry to the transceiver 22, memory 24, UI 26 and the SIM 29. The non-volatile memory is entirely or at least partly reprogrammable during the use of the mobile communication device 2 so that desired information such as new applications or patches to old applications may be downloaded over-the-air and stored in the memory 24 so that it is maintained without a normal power supply to the mobile communication device 2. The mobile communication device 2 comprises further components to provide the operation of a modern mobile telephone, but only components useful for describing the invention are listed and described. The operation of the mobile communication device 2 will be described with reference to FIGS. 4 and 5. The input section 27 may comprise a dedicated button, speech recognition configured to recognise a predetermined command or a soft key to detect a user command for causing content be delivered to a friend. In case of a soft key, the mobile communication device 2 may display a legend such as “game” next to which a key may be provided to offer an access to game related functions such as “game sounds”, “game options”, “multiplayer game ”and “online menu”. The online menu (or the game menu) may comprise further options such as “download enhancements” (e.g. further levels or enhanced properties for characters in a game), “recommend to a friend” and “buy more use”. Hence, to cause a game played be delivered to a friend, a user simply can press the soft key “game”, then be presented a list of menu options “game sounds” to “online menu”, choose the “online menu” and then “recommend to a friend” in a fashion known from soft key operable menus. After this, the friend's telephone number may be inputted either as numbers from a keypad or via reference to a local or distributed phonebook to complete the content redistribution. Hence, no detailed technical understanding is required by a user to cause the content be delivered to the friend, as will be described in more detail.

FIG. 3 shows a block diagram of a content provider 3 of FIG. 1. The content provider 3 is typically a server computer connected either directly or via computer networks to the mobile communications network 4. The content provider 3 comprises a processor 31 and an Input/Output (IO) 32, mass memory 33 storing operating instructions 34 for the content provider 3 and a content database 35 having a plurality of content items 36 such as games, graphics, pieces of music and/or video clips. The processor 31 is connected either directly or via other components such as data buffers to the IO 32 and to the mass memory 33. The IO 32 and the mass memory 33 may be capable of direct memory access to each other for exchanging data without causing strain on the processor 31. The IO 32 may comprise an administration section 37 for administrative access such as operating system updates and particularly for content maintenance where the content items 36 available to customers may be updated by adding, deleting or changing one or more content items 36. Alternatively, the content administration may take place by accessing the content database 35 by another server. The operation of the content provider will be described in more detail in connection with FIG. 6.

FIG. 4 shows a flow chart illustrating the operation of the mobile communication device 2 of FIGS. 1 and 2 when sending a pointer to a desired content (that is, content item 36). The starting point is that the mobile communication device 2 may have been presenting or running a particular content that has attracted the attention of a friend of the user of the mobile communication device 2. The friend may have asked to have the content. FIG. 4 illustrates steps taken at the mobile communication device 2 to cause another mobile communication device of the friend to receive the content. The flow chart starts from step 41, wherein the mobile communication device 2 receives a content forwarding command from the input section 27. Responsive to the content forwarding command, in step 42 the mobile communication device 2 prompts and inputs an identification of the friend, such as his or her telephone number. A local phone book held at the mobile communication device 2 may be used for picking up this identification. Once the identification has been obtained, a pointer will be sent to either the content provider 3 or to the friend, in accordance to two different embodiments of the invention. Both of these may be supported by the mobile communication device 2, but in the following these two embodiments will be described starting from the scenario in which a pointer to the friend is sent to the content provider 3 for the content provider to then approach the friend's mobile communication device (which corresponds to the mobile communication device 2).

When the pointer is sent to the content provider, the pointer only needs to contain an identifier of the content that is being provided to the friend and the identification of the friend. The content to be provided need not be the same as the content presently used at the mobile communication device 2, but preferably the user of the mobile communication device 2 may choose any content received from the content provider 3 to be pointed by the pointer. Hence, in step 43 the mobile communication device 2 sends the pointer to the content provider 3. The pointer may be transmitted over a signalling channel or over a data or traffic channel. For instance, Short Message Service SMS, GPRS, GSM Data or any other mechanism may be used for transmitting the pointer. A personal message may be attached with the pointer. This message may be relayed to the friend's mobile communication device so that friend may be greeted and also may be convinced that the content to be received is indeed being provided based on the friend's recommendation and not just any arbitrary unsolicited message. The pointer may also contain more than one identifier and/or identification: The user of the mobile communication device 2 may desire to recommend one or more content to one or more people. The choice of these identifiers and/or identifications may make use of predefined grouping of various different content items and/or contacts in a local contact database (e.g. local phone book). The pointer may have a structure as shown in FIG. 7.

When the pointer is sent to the friend's mobile communication device rather than to the content provider, the pointer need not contain the identification of the friend (instead, that information is used for addressing the pointer), but instead an address of the content provider is included in the pointer. Again, the content to be provided need not be the same as the content presently used at the mobile communication device 2 and identifiers for numerous different content items and / or a personal message may be included in the pointer. Further, the pointer may be sent directly to a group (possibly predetermined). In order to facilitate the obtaining of the content by the mobile communication device of the friend, the mobile communication device 2 preferably formats the pointer such that it will automatically cause the receiving mobile communication device to initiate communications and identify the content(s) desired to the content provider 3. Hence, in step 44, the mobile communication device 2 forms a pointer to be sent for one or more friends for one or more content as identified in step 42. In step 45, the mobile communication device 2 sends the pointer to the one or more mobile communication device to which the pointer is formed.

After step 43 (or 45, as the case may be), the mobile communication device 2 will return to step 41. It should be appreciated that during the procedure of FIGS. 4 and 5, the mobile communication device 2 may continue to otherwise operate as a normal mobile communication device that is to transmit and receive messages and be ready to receive phone calls, for instance.

Sending a pointer to the content provider 3 is advantageous in providing the content provider with a reliable and real-time information of the distribution mechanism of the content. Further, the mobile communication devices need not be compatible with each other: it suffices that the content provider is compatible with each of them. For instance, the mobile communication device 2 of the recommender may run Java and the friend's mobile communication device may run a competing, non-compliant software for which the content provider yet has a compatible version of the content. The friend's mobile communication device need not have any particular capability on top of generic WAP compatibility, as the content provider 3 may simply interact with it within the framework provided by WAP (which supports content pushing and capability negotiation wherein the client capabilities may be carried to a WAP gateway on setting up a session for data transfer). The forwarding of a pointer received directly from a friend to a content provider identified in that directly received pointer is not a standard operation readily provided by WAP, for instance, and therefore any arbitrary WAP compliant mobile telephone would not support the other embodiment until complemented with a software upgrade or addition.

The embodiment in which the pointer is directly relayed to the another mobile communication device(s) is advantageous as it enables non-charged recommending of the content even without any connection cost subsidising. Bluetooth, infrared and direct cable connections are free of charge and may hence be preferred to a recommender to sending a recommendation to the friend via the content provider 3. Further, battery power of the mobile communication device 2 and radio resources in the mobile communications network 4 may be spared and the recommender has little or no risk of revealing the friend's mobile address or telephone number to unsolicited advertisers.

FIG. 5 shows a flow chart illustrating the operation of the mobile communication device 2 of FIGS. 1 and 2 when receiving a pointer to a desired content that is when the mobile communication device 2 is in effect the friend's mobile communication device referred to in the foregoing.

In step 51, the mobile communication device 2 receives a pointer from the friend. Depending on the implementation, the mobile communication device 2 may automatically retrieve the content from the content provider 3 without presenting any questions at all to the user, but preferably as a precaution the mobile communication device 2 prompts before incurring any fees (for instance, before sending any outgoing data) its user to accept the obtaining of the content. In this connection, the mobile communication device 2 preferably displays the message from the originating user. This message may not only contain a personal greeting, but also gives the price for the content if known by the originator. The price may have been also automatically inserted by the mobile communication device 2 on forming the pointer. In any case, in step 52 the mobile communication device 2 sends a request to the content provider 3 (either automatically or after approval of the user). This request may be coded together with the expected price or with a maximum acceptable price (that may be predetermined particularly if automatic content retrieval has been accepted). The automatic content retrieval may also be subject to accumulated costs incurred over a predetermined period such as past month.

In step 53 the mobile communication device 2 receives a content order approval request. In step 54, responsive to the approval request, the mobile communication device 2 prompts for an approval and when approved requests in step 55 for the content delivery. These steps 53 to 55 are optional.

In step 56, the mobile communication device 2 receives the content(s) pointed by respective identifier(s). This step may be invoked by a push mechanism in which a remote content provider may automatically push content to the mobile communication device 2. Alternatively, the mobile communication device 2 may be programmed, for instance by a Java application or applet, in effect to provide for a push type of experience in which no manual user interaction is necessary to receive the content. After step 56, the procedure continues to step 51.

In case of a pointer being sent to the content provider, the operation at the friend's mobile communication device 2 may proceed directly from step 53 or 56, as will be explained next with reference to FIG. 6.

FIG. 6 shows a flow chart illustrating the operation of the content provider 3 of FIG. 1 in one embodiment wherein the mobile communication device 2 has sent to the content provider 3 a pointer with an identification of a friend. In step 61, the content provider 3 receives a pointer with the identification of one or more subscribers 2 of a mobile communications network and one or more identifiers of content items 36, as an indication of friend recommendation for content provision to these subscribers. In step 62, the content provider may reward the recommender or the mobile communication device 2 from whom the pointer was received with an award for promoting the business of the content provider. In step 63, the content provider 3 seeks for respective content items. After finding a desired content item matching with an identifier in the pointer, the content provider prepares to deliver the content item to a subscriber matching with the identification. The preparing may involve sending first an approval request in step 64 and proceeding only if a request for delivery is responsively received in step 65, corresponding to steps 53 to 55. Alternatively, the content provider may directly proceed in step 66, particularly if the content item being provided is free of charge or if the content provider 3 has a standing agreement with the subscriber to whom the content is being provided to the extent of costs being charged. In step 66, the content is provided to the subscriber with matching identification (friend) and the transaction is charged or recorded for charging. The charging may take place by any means known in the art, such as charging via a mobile communications network operators accounting server or by requiring a prepayment to an account held by the content provider, for example. The providing of the content preferably takes place by using a push-mechanism such as WAP push. Multimedia messaging service may also be used to convey the content.

In case more than one identifier for more than one content item has been included in the pointer, the content provider may provide all or part of them in a common message, although it is generally clearer for the friend in question to perceive the receiving the content items if they are each delivered separately.

In step 67 after successfully providing the content and particularly charging for the content the content provider 3 may award the recommender again preferably with a larger award than in step 62. The awarding in both steps 62 and 67 may grant the recommender with a direct payment or reduction of the cost for downloading new content items from the content provider. This scheme of awarding recommenders is useful as it encourages to tell friends and promote the business of the content provider 3. However, either or both of steps 62 and 67 may be skipped.

FIG. 7 shows a flow chart illustrating the operation of the content provider of FIG. 1 in another embodiment wherein the mobile communication device 2 has sent to another mobile communication device 2 a pointer to the content provider. In step 71, the content provider receives first a pointer from the friend's mobile communication device 2 that is the mobile communication device that has earlier received another pointer pointing to the content provider and a particular content retrievable via the content provider. The content provider receives at least the identifier(s) corresponding to desired content(s) and the identification of the requesting subscriber, wherein the latter may be handily provided in form of an A-subscriber number. The content provider may further receive an identification of the recommender from whom the requesting subscriber or mobile communication device 2 has earlier received the identifier(s), for awarding the recommender. After step 71, the content provider proceeds to steps 63, 66 and 67 described with reference to FIG. 6. As opposed to the situation behind FIG. 6, the steps 64 and 65 will not be required since the reception of the pointer in step 71 readily confirms the desire of the paying for the content, at least if the price of the content was known by the requesting mobile communication device 2. The content provider may first check the pointer received for a price of the content and to skip steps 64 and 65 only if the price matches and otherwise request for express approval. This may be needed if the price has increased or if the price was not conveyed from the recommender to the friend or the requesting mobile communication device 2.

In case of games as the content, the mobile communication devices may be configured to store each other's identities for further use in over-the-air multiplayer game sessions be easily started. For instance, the friend's mobile communication device 2 may be configured to provide an option in the game menu—online menu—to play against the recommender. As a business proposition, the content provider may charge for the multiplayer mode with per minute or per game basis and award the winner by a free on-line game (in which the content provider would be able to charge the other player(s) of the multiplayer session). This type of reuse for the identities provides clear synergy.

The delivery of the content to the another mobile communication device 2 of the friend may be seen as redistribution of the content caused by the mobile communication device 2 of a recommender without direct transfer of the content between the mobile communication devices. This redistribution is advantageously partly or entirely automatic after being initiated, except for a possible confirmation step in which the friend may confirm the redistribution before any substantial costs are incurred.

The present invention may be embodied in various forms without departing from its essential attributes. It should be appreciated that the entire detailed description describes a preferred embodiment and can be freely varied by removing, replacing or adding features of this detailed description. That the various features described are optional has not been emphasised for each feature only in sake of clarity and conciseness of the description. Furthermore, each feature disclosed in this specification (which terms includes the claims) and/or shown in the drawings may be incorporated in the invention independently of other disclosed and/or illustrated features. In this regard, the invention includes any novel feature or combination of features disclosed herein either explicitly, implicitly or any generalisation thereof irrespective of whether or not it relates to the claimed invention or mitigates any or all of the problems addressed.

1. A mobile communication device, comprising:
a receiver for receiving electronic content from a content provider;
a user interface for receiving a user command;
a transmitter configured to cause the content provider to deliver the content to another mobile communication device responsive to the user command.

2. A mobile communication device according to claim 1, wherein the content is a game playable with a mobile communication device or content to be presented such as video, music or news content.

3. A mobile communication device according to claim 1, wherein the mobile communication device may comprise an input for receiving a user command to cause presently used content to be delivered to the another mobile communication device.

4. A mobile communication device according to claim 1, wherein the transmitter has been configured to transmit an identifier associated with the content to the content provider and an identification of the another mobile communication device.

5. A mobile communication device according to claim 4, wherein the identifier is a checksum computed on the content or a predetermined part of the content.

6. A mobile communication device according to claim 4, wherein the identifier contains an identifier received from the content provider before, after or on receiving the content.

7. A mobile communication device according to claim 4, wherein the identifier comprises man and/or machine readable information.

8. A mobile communication device according to claim 4, wherein the identifier comprises a computer executable code sequence adapted to cause a mobile communication device to start fetching the content from the content provider.

9. A mobile communication device according to claim 8, wherein the computer executable program code sequence comprises all the information necessary to initiate a communication link with the content provider.

10. A mobile communication device according to claim 1, wherein the transmitter has been configured to send the identifier to the another mobile communication device to cause the delivery of the content to the another mobile communication device.

11. A mobile communication device according to claim 1, wherein the transmitter has been configured to send the identifier over a point-to-point connection.

12. A mobile communication device according to claim 1, wherein the transmitter has been configured to send the identifier over a short range wireless connection.

13. A content provider, comprising:
an input for receiving from a first mobile communication device a content delivery request, an identifier associated with the content and an identification of a second mobile communication device;
an access to a collection of different contents; a content finder configured to find a particular content based on the received identifier;
an output for outputting the content requested for the second mobile communication device

14. A content provider according to claim 13, wherein the input has been configured to deliver the content to the first mobile communication device and later responsive to the delivery request to deliver the content to the second communication device.

15. A content provider according to claim 13, wherein the content provider comprises an identifier combiner configured to combine an identifier associated with the content before or on delivering the content to the first mobile communication device.

16. A content identifier, comprising means for initiating a data communications link with a content provider and means for identifying a particular content for downloading that content from the content provider.

17. (canceled)

18. A content delivery system according to claim 17 comprising a mobile telecommunications network for relaying information between the content provider and the mobile communication device.

19. A computer program product for controlling a mobile communication device to operate as a mobile communication device according to claim 1.

20. A computer program product for controlling a content provider to operate as a content provider according claims 13.

21. (canceled)
